(19) United States
(12) Patent Application Publication
(10) Pub. No.: US 2010/0313752 A1
(43) Pub. Date: Dec. 16, 2010

(54) GAS SEPARATION MEMBRANES AND PROCESSES FOR THE MANUFACTURE THEREOF

(75) Inventors: Clem Evans Powell, Melbourne (AU); Greg Guang Hua Qiao, Doncaster East (AU); Sandra Elizabeth Kentish, Kew East (AU)

Correspondence Address: BLANK ROME LLP, ONE LOGAN SQUARE, PHILADELPHIA, PA, 19103, US

(73) Assignee: CO2CRC TECHNOLOGIES PTY LTD, Barton (AU)

(21) Appl. No.: 12/741,297

(22) PCT Filed: Nov. 5, 2008
(86) PCT No.: PCT/AU2008/001639

§ 371 Date: Aug. 31, 2010

Related U.S. Application Data
(60) Provisional application No. 61/001,879, filed on Nov. 5, 2007.

(30) Foreign Application Priority Data
Nov. 5, 2007 (AU) 2007906042

(51) Int. Cl. B01D 53/46; B01D 53/22; B01D 53/62; B01D 71/06; B01D 71/64; C08J 9/00

(52) U.S. Cl. 95/45; 96/4; 96/14; 521/154

(57) ABSTRACT

The present invention relates to gas separation membranes for separating carbon dioxide from other gas species, polymer compositions suitable for this application, and processes for the manufacture thereof. In particular, the present invention relates polymeric compositions comprising a host polymer that is permeable to the targeted gas species, such as carbon dioxide and has a selectivity for the target gas species over other gas species. The polymeric composition also comprises domains of a polymeric material that are, for example at least 0.5 nm in diameter and that have a higher permeability for the targeted gas compared to the host polymer. The present invention can provide membranes that have a permeability and selectivity above the Robeson's upper bound.

### FIELD OF THE PRESENT INVENTION

The present invention relates to gas separation membranes for separating different gas species, polymer compositions suitable for this application, and processes for the manufacture thereof.

### BACKGROUND OF THE PRESENT INVENTION

Gas molecules are transported through permeable polymeric membranes by various mechanisms including solution-diffusion mechanisms, Knudsen diffusion and molecular sieve. The relationship between permeability, diffusivity and solubility can be described by the following equation:

P=DS

where P is the permeability coefficient (cm³ (STP) cm cm⁻²s⁻¹ cmHg⁻¹; a measure of the flux of the membrane), D the diffusivity coefficient (cm²s⁻¹; a measure of the mobility of the molecules within the membrane) and S is the solubility coefficient (cm³ (STP) cmHg⁻¹; a measure of the solubility of gas molecules within the membrane). The common measurement of P is the barrer (10⁻¹⁰ cm³ (STP) cm cm⁻²s⁻¹ cmHg').

Gas separation membranes are used or have the potential to be used in various industrial processes including the production of oxygen enriched air, separation of moisture or carbon dioxide from natural gas, and the recovery of gas from vented gases such as flue gas of coal and natural gas power stations. While the composition of the flue gases of power plants varies greatly depending on the fuel source, the flue gases tend to be oxidizing and generally consist of N₂, O₂, H₂O, CO₂, SO₂, NOₓ and HCl. Gas separation membranes are required to separate a target gas species from a mixture of gases. One gas that is often the target gas to be separated from one or more other gasses in a mixture is CO₂. CO₂ is in this event is desirably separated from H₂, N₂ and/or CH₄. Other desirable gas separations include O₂/N₂ (i.e. oxygen gas from nitrogen gas), He/N₂ and He/CH₄.

Polymers used for gas separation membranes have to meet certain criteria. One is the ability for gas to permeate through the membrane, so a reasonable gas flux is achieved during separation. A second criterion is the selective separation of the target gas from other gases i.e., the selectivity of the membrane. In simple terms, selectivity is measured as the permeability of the target gas—gas A (P_{A}) over the permeability of the other gas species—gas B (P_{B}):

P_{A}/P_{B}.

A third criterion is that the membrane needs to provide good thermal and mechanical properties, to provide structural stability for the gas separation membrane in the separation process, which may be conducted under pressure.

The two criteria of permeability of the membrane to the gas, and selectivity of the membrane to the target gas over another gas are usually counter to each other. Increasing the permeability of a membrane tends to decrease its selectivity (as it tends to increase in permeability for all gases). Likewise, increasing the selectivity of the membrane for a target gas over another gas tends to decrease its permeability to the target gases (as the restriction of flow of the non-target gas through the membrane tends to restrict flow of all gases, even though the restriction of flow of the target gas is not as severe). This effect has been studied, and the upper boundary on the combination of permeability and selectivity has been plotted. The plot of the upper boundary of permeability against selectivity is known as Robeson's upper bound (Journal of Membrane Science, 1991, 62, pg 165). In general, it has been found to be difficult to develop membranes that provide a combination of permeability and selectivity that is above Robeson's upper bound.

It is an object of the present invention to provide a gas separation membrane, a polymer composition suitable for forming gas separation membranes, and a process for its production, which can provide an improvement in the combination of permeability and selectivity for the separation of a target gas from a gas mixture.

### SUMMARY OF THE PRESENT INVENTION

According to the present invention there is provided a gas separation membrane for separating a target gas species from a second gas species in a gas mixture, the membrane comprising:
a host polymer which is permeable to the target gas species and has selectivity for the target gas species over the second gas species, and
domains of a polymeric material having a higher permeability for the target gas compared to the host polymer.

The domains of polymeric material having a higher permeability for the target gas are typically of at least 0.5 nm and preferably at least 1 nm in diameter.

While the host polymer provides the basic level of permeability and selectivity for the target gas species over the second gas species, the domains of polymeric material of greater permeability assist the transport of the target gas through the membrane (which is often retarded in highly selective membranes) without reducing selectivity of the membrane to a prohibitively low level. This enables the gas separation membrane to have a combination of permeability and selectivity that takes it above Robeson's upper bound.

By selecting a suitable host membrane that provides permeability and selectivity for a specific target gas species over a specific second gas species, and is also physically and chemically robust, a membrane that is suitable for any gas combination can be prepared.

For a gas separation membrane that is specific to CO₂ as the target gas species, the second gas species may be N₂, H₂, CH₄, O₂, H₂O, H₂S, SOₓ, NOₓ, preferably H₂, N₂ or CH₄. Other possible target gases for which host polymers and domain polymeric materials can be readily selected based on this principle are He, O₂ and N₂.

According to the present invention there is also provided a polymer composition for forming a gas separation membrane, the polymer composition comprising:
a host polymer which is permeable to the target gas species and has selectivity for the target gas species over the second gas species, and
domains of a polymeric material having a higher permeability for the target gas compared to the host polymer.

The domains may be provided by a number of different techniques. According to one technique, the domains are independent to the host polymer and comprise polymer particles that are dispersed in the host polymer. According to another technique, the domains are formed by aggregated regions of sections of polymeric material located within the host polymer.

According to one embodiment, the polymeric composition produced by combining a host polymer which is permeable to a target gas species, and has selectivity for the target gas species over a second gas species, and polymeric particles of a second polymeric material having a particle size of at least 1 nm, wherein the second polymeric material has a higher permeability for the target gas compared to the host polymer.

This process may further involve:

preparing a solution comprising:
the host polymer which is permeable to a target gas species, and has selectivity for the target gas species over a second gas species,
the polymeric particles of a second polymeric material having a particle size of at least 0.5 nm and preferably at least 1 nm, wherein the second polymeric material has a higher permeability for the target gas compared to the host polymer, and
a solvent;
   and removing the solvent to produce the polymeric composition comprising a host polymer with the polymeric particles distributed therein.

According to another embodiment, the polymeric composition is produced by reacting:

(i) a host polymeric material or precursor having at least one reactive end group of a first type, with

(ii) domain-forming polymeric material segments having at least one reactive end group of a second type which is reactive with the end group of the first type, to produce a polymeric composition in which multiple segments of the second polymeric material aggregate to form domains within the host polymer, wherein the host polymer is permeable to a target gas and has selectivity for the target gas over a second gas, and the domain-forming polymeric material has higher permeability to the target gas compared to the host polymer.

According to one alternative, the host polymeric material precursor being reacted has one or two reactive end groups, and the domain-forming polymeric material segments being reacted have two reactive end groups, and the method involves reacting at least a 2:1 mole ratio of the host polymeric material to domain-forming polymeric material to produce a polymeric composition comprising 3-block units of reacted polymer comprising a segment of domain-forming material between two segments of host polymeric material. The product may also contain unreacted host polymeric material, especially if in excess of a 2:1 mole ratio of host polymer to domain-forming polymer is used, and if the host polymeric material contains only one reactive end group.

According to another alternative, the host polymeric material being reacted comprises multiple reactive pendent groups, and the second polymeric material segments each have multiple reactive end groups, so that the reaction yields a cross-linked polymeric composition comprising the host polymeric material and segments of second polymeric material.

The present invention also provides for the use of the polymeric material described above as a gas separation membrane. The present invention further provides a method of separating a target gas from a second gas in a gas mixture comprising passing the gas mixture through or alongside the gas separation membrane described above.

The gas separation membrane, polymers and mixtures in accordance with the various embodiment of the present invention can be used for a variety of different membrane conformations. This includes, but is not limited to, dense membranes, intrinsically skinned membranes or attached to a substrate to act as a selective layer. The membranes may have any geometry such as flat sheet, hollow fibre or spiral wound forms.

One of the benefits of the present invention is that the capacity of the membrane to separate the targeted species is influenced by the permeability and selectivity of the polymeric film and the affinity of the domains for the targeted species. Increasing the solubility of the membrane to the target gas by introducing such domains having a higher solubility increases the flux of the targeted species and yet offers the capacity to maintain a desirable selectivity for the targeted species over other gas species. Another advantage of the membrane and methods of the present invention is that membranes of the desired composition can be easily constructed via existing processes by altering the polymer feedstock composition. A further advantage is the ability to the membrane to incorporate a host polymer which aids the structural integrity of the membrane substantially allowing the use of domain forming polymers which would normally be prohibitive due to their lack of structural integrity or membrane forming ability.

### BRIEF DESCRIPTION OF THE FIGURES

FIG. 1 is a diagram of the variable pressure gas permeation apparatus for determining permeability of a polymeric composition to a specific gas. In FIG. 1:

### 1=Standard Pressure Gauge 0-4000 kPa

### 2=Pressure Transducer 0-6800 kPa

### 3=Type K Thermocouple

### 4=Pressure Transducer 0-10 Torr

### 5=Data Logging PC

### 6=Cylinder Gas Supply

### 7=Heating Loop

### 8=Membrane Holder

### 9=Fan Forced Oven

### 10=Calibrated Volume

### 11=Vent

### 12=Vacuum Supply

### 13=Vacuum Supply

### 14=Pressure Relief

### 15=Thermostatic Controlled Waterbath

FIG. 2 is a sketch of the structure of a polymeric composition for forming the gas separation membrane of one embodiment of the invention.

FIG. 3 is a scanning electron micrograph (SEM) of a polymeric composition for forming a gas separation membrane of another embodiment of the invention comprising 2.5 w/v % PDMS star polymer in a 6FDA-durene membrane.

FIG. 4a sets out the SEM-Energy Dispersive X-ray Spectroscopy (SEM-EDS) results for areas of the membrane illustrated in the SEM of FIG. 3 having the “white blobs”. FIG. 4b sets out the SEM-Energy Dispersive X-ray Spectroscopy (SEM-EDS) results for areas of the membrane illustrated in the SEM of FIG. 3 having the “black areas”. The different carbon to silica ratios in the two samples are notable features.

FIG. 5 is a graph of core cross-linked star polymer (CCSP) concentration against carbon dioxide and nitrogen permeabilities which shows the effect of increasing the concentration of CCSP on carbon dioxide and nitrogen permeabilities.

FIG. 6 is a sketch of the polymeric composition for forming the gas separation membrane of another embodiment of the invention, comprising triblock copolymers in linear polyimide membranes. The thicker lines radiating from the centre represent the polyimide and thinner lines extending out from those lines represent the PDMS. While a micelle like structure is drawn here, the exact structures formed will depend on the molecular weights of the various blocks.

FIG. 7 is a graph of carbon dioxide pressure against carbon dioxide permeability, and shows the effect of carbon dioxide pressure on the carbon dioxide permeability of membranes synthesized via one embodiment of the invention (approach 2). 6FDA-durene is included as a comparison.

FIG. 8 is a graph of carbon dioxide permeability against carbon dioxide/nitrogen selectivity of membranes constructed according to two embodiments of the invention (approach 1 and 2) relative to literature examples.

FIG. 9 is a graph of carbon dioxide permeability against carbon dioxide/nitrogen selectivity of membranes constructed according to two embodiments of the invention (approach 1 and 2) relative to literature examples. The examples from this document are displayed as squares. The broken line in the graph is Robeson's upper bound.

FIG. 10a is a transmission electron micrograph (TEM) of a polymeric composition for forming a gas separation membrane of another embodiment of the invention comprising membrane constructed using 1:1 6FDA:PDMS triblock. FIG. 10b is a transmission electron micrograph (TEM) of a pure homopolymer sample.

### DETAILED DESCRIPTION

### Host Polymer/Host Polymeric Material

The host polymer can be any gas separation membrane polymer material known in the art that provides a combination of permeability for the target gas and selectivity for the target gas over a second gas species.

The host polymer may be selected generally from polyamides and polyimides, including aryl polyamides and aryl polyimides; polyacetylenes; polyanilines; polysulfones; poly(styrenes), including styrene-containing copolymers including acrylonitrilestyrene copolymers, styrene-butadiene copolymers and styrene-vinylbenzylhalide copolymers; polycarbonates; cellulosic polymers including cellulose acetate-butyrate, cellulose propionate, ethyl cellulose, methyl cellulose, and nitrocellulose; polycarbonates; polyethers; polyetherimides; polyetherketones; poly(arylkene ethers); poly(arylene oxides) including poly(phenylene oxide) and poly(xylene oxide); poly(esteramide-diisocyanate); polyurethanes; polyesters (including polyarylates) such as poly(ethylene terephthalate), poly(alkyl methacrylates), poly(acrylates), poly(phenylene terephthalate), poly(phenylene oxide)s; poly(pyrrolone)s; polysulfides; poly(ethylene) including poly(ethylene oxide); poly(proylenes), polymers of intrinsic microporosity and polyvinyl compounds.

Preferred polymer materials are condensation polymers formed from two different monomer units (“A” and “B”), which react to produce a polymer with alternating units of A and B. Preferred host polymer materials contain aromatic rings within the backbone of the polymer coming from at least one of the monomer units. The “backbone” of the polymer is to be distinguished from pendant groups which do not form part of the polymeric backbone.

The host polymer will be selected based on the properties of permeability for the target gas and selectivity for the target gas over a second gas species.

The permeability properties and selectivity properties for many host polymer materials in the art are well known and have been extensively studied, and this data can be used to identify a suitable host polymer for a given application. The permeability of the host polymer is preferably at least 5 barrer.

A suitable technique for calculating the permeability of a given host polymer for a specific gas (such as the target gas) involves the procedure outlined in the following two paragraphs:

The polymer is synthesized and dissolved in a solvent such as dichloromethane (AR grade, used as received from Ajax Finechem) at a concentration of 2.5 wt/vol %. Solutions are filtered through 0.75 μm glass fibre filters (Advantec), before being solution cast using glass casting rings. Drying was complete in two stages. Initial drying is at room temperature for approximately 48 h, with the casting ring covered with a Petri dish, ensuring a near-saturated environment immediately above the membrane. Films are then removed from glassware using distilled water, before being dried in vacuo firstly at 80° C. for 15 h, then at 150° C. for 48 h. Absolute pressure in the vacuum oven is approximately 3 kPa. Membranes are stored in a desiccator until use. Membrane thicknesses are measured using a micrometer (Mitutoyo, Japan) with an accuracy of approximately ±1 μm. The measured thickness need to be between 40 and 50 μm.

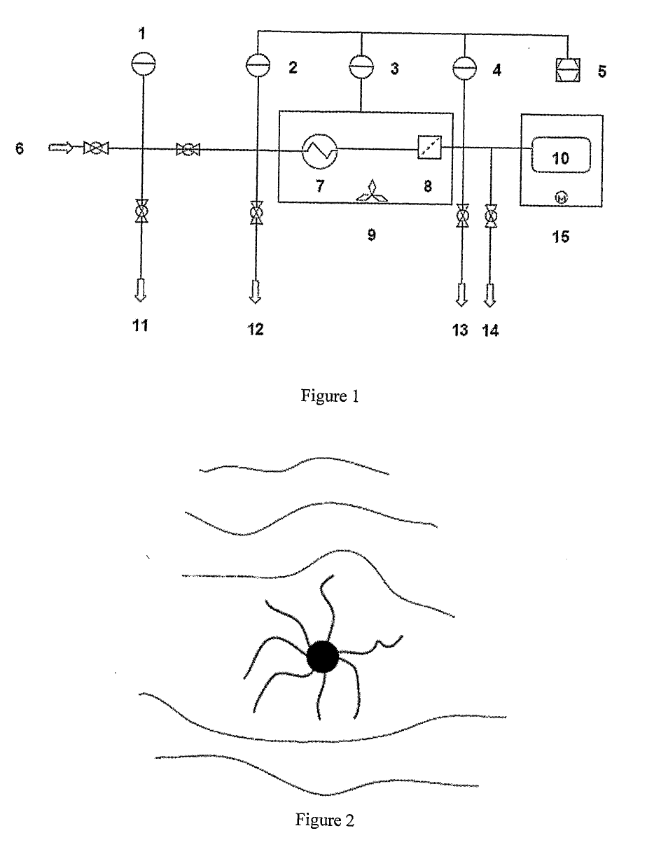

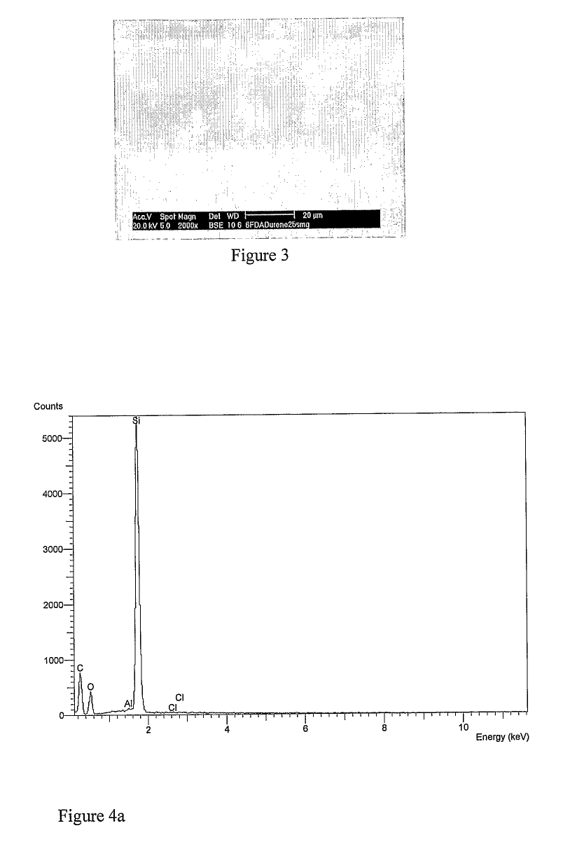

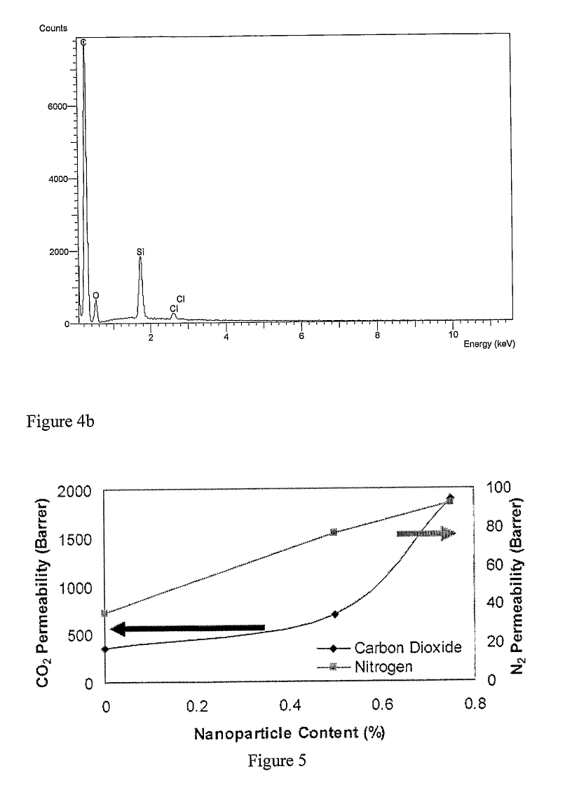

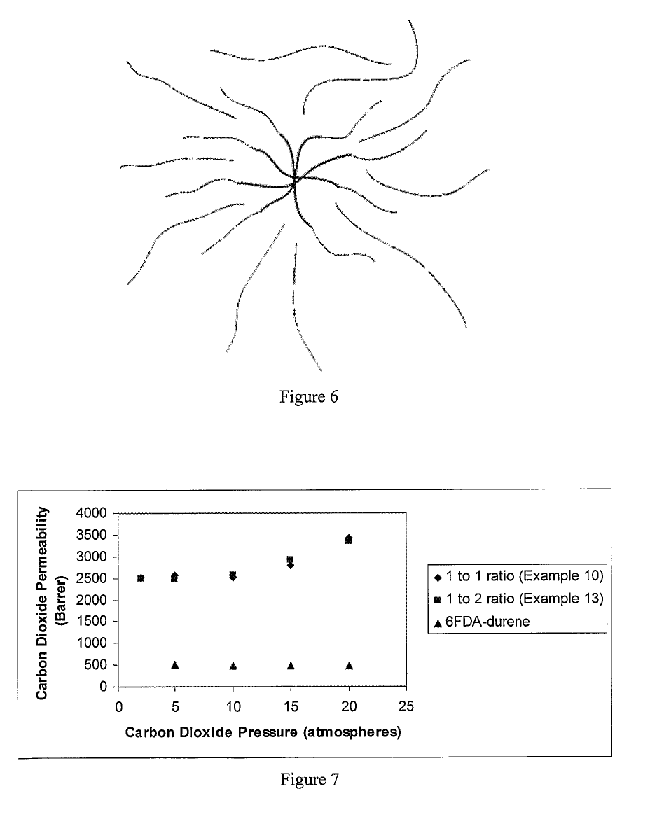

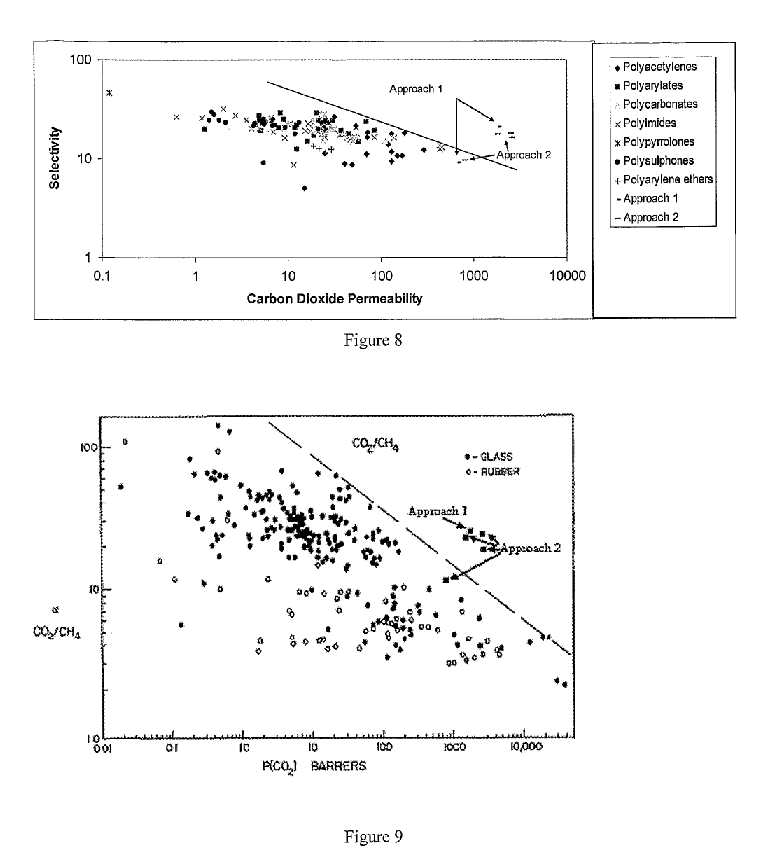

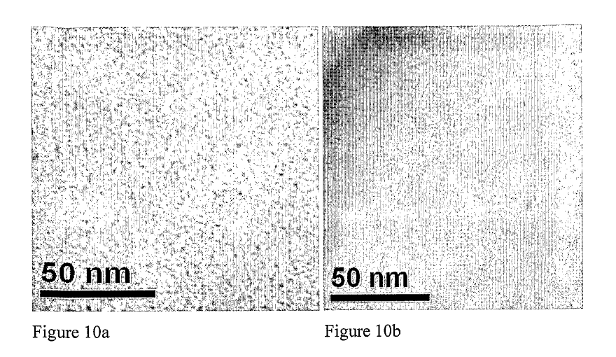

Permeabilities are measured with a constant volume, variable pressure gas permeation apparatus (FIG. 1). The apparatus operates by supplying feed gas at a constant pressure of 10 Atm to a pre-heating loop before proceeding to a sealed membrane unit. The unit is a dead end high-pressure filter holder of cross-sectional area 47 mm. The heating loop and membrane unit are housed in an oven that is temperature controlled at 35° C. The permeate gas passes into a cooling loop that is housed in a water bath, ensuring a constant measurement temperature of 27.5±0.2° C. Data is logged electronically at a rate of 1 read per second, with each data point being an average of 100 individual pressure measurements. Gas feed pressures are determined with an MKS Baratron® transducer of range 0−7000 kPa absolute pressure, while downstream volumes are measured with an equivalent model of 0−1.3 kPa absolute pressure.

It is noted that the above test for determining permeability sets the requirements for assessing permeability. When the membrane is being synthesized commercially, different parameters may be used. As examples, the solvent in commercial synthesis may be a solvent other than dichloromethane, and the concentration of polymer in the solvent may be varied.

It is noted that in the gas separation membrane of the present invention, the domains of a second polymeric material may be formed by segments of that second polymeric material within the host polymer. In this event, the host polymer for the calculation of the permeability to a specific gas is measured as the host polymer in the absence of the second polymeric material (as a homopolymer).

The selectivity of the host polymer for a target gas over a second gas in a gas mixture is determined by dividing the permeability of the host polymer for the target gas by the permeability of the host polymer for the second gas, where the permeability for each gas is measured by the technique outlined above. According to one embodiment, the selectivity of the host membrane for the target gas species over the second gas species is at least 4, and more preferably at least 8. The selectivity of the gas separation membrane is preferably also at least 4, and more preferably also at least 8.

Suitable host polymer membranes may be selected from any of the polymers described in the Review “Polymeric CO₂/N₂ gas separation membranes for the capture of carbon dioxide from power plant flue gases”, J. Mem. Sci, 279 (2006) 1-49 (hereafter referred to as “the Review”), the entirety of which is hereby incorporated by reference.

Typically, the suited host polymer materials have glassy structure, or have a relatively flat, rigid structure with kinks that impact on packing. Thus, aromatic rings are common structural motifs found in such host polymer materials for gas separation applications.

One suitable class of host polymer materials, particularly for the separation of carbon dioxide from other gases, are the polyimides. Polyimides are frequently synthesised by the (condensation) reaction of diamine with a dicarboxylic acid (such as a dianhydride) in a polar solvent. An intermediate formed in the polymerisation is polyamic acid, which undergoes a condensation reaction to form the polyimide.

Examples of suitable dicarboxylic acids/dianhydrides for forming polyimide host polymers include 4,4′-(hexafluoroisopropylidene)-diphthalic anhydride (6FDA), 3,3′,4,4′-bisphenyltetracarboxylic dianhydride (BPDA), 4,4′-oxydiphthalic anhydride (OPDA), 3,3′4,4′-benzophenonetetracarboxylic acid dianhydride (BTDA), 1,2,3,5-benzenetetracarboxylic anhydride (PMDA) and 1,4,5,8-naphthalenic tetracarboxylic dianhydride (NTDA).

Suitable diamines for the formation of the host polymer include 2,2′-bis(3-amino-4-hydroxylphenyl)hexafluoropropane (bisAPAF), 4-(4-aminophenoxy)benzenamine (4,4′-ODA), 3-(4-aminophenoxy)benzenamine (3,4′-ODA), 3-(3-aminophenoxy)benzenamine (3,3′-ODA), 1,4-diaminodurene, 2,5-diamino-1,4-benzenedithiol (DABT), 5-amino-1-(4′-aminophenyl)-1,3,3-trimethylindane, 6-amino-1-(4′-aminophenyl)-1,3,3-trimethylindane and 3,3′-diaminobenzidine (DAB).

### Domains of Second Polymeric Material

The domains of second polymeric material (also described as domain-forming polymeric material or segments) may be constituted by polymer particles that are independent of the host polymer, or they may be constituted by segments of second polymeric material within the host polymer structure, which aggregate (due to phase separation of the second polymeric material within the polymeric composition) to form domains of that second polymeric material.

To calculate the permeability of the second polymeric material, a sample of a polymer made entirely from the second polymeric material is subjected to the permeability test to calculate the permeability of that second polymeric material to the specific gas, such as the target gas. If available, literature data on the permeability of a given second polymeric material may be relied upon. The second polymeric material preferably has moderate to high permeability to the target gas (i.e. high solubility for the target gas).

The second polymeric material—either in the form of particles or segments—may be selected from any polymeric material with a higher permeability for the target gas compared to the host polymer. Generally the permeability of the second polymeric material will be at least 50% as permeable to the target gas compared to the host polymer and preferably three times as permeable.

The second polymeric material or domain-forming polymer segments suitably contain either:
a charged group, and suitably a charged end group
one or more polar groups (including carbonyl, hydroxyl, amine, ether, siloxane etc) and suitably a polar end group
the presence of one or more heteroatoms (i.e. non-carbon and hydrogen atoms), such as oxygen, nitrogen, silica, fluorine.

Examples of suitable polymeric materials for forming the domains of second polymeric material are one or a combination of polydisubstitutedsiloxane, such as the polydialkylsiloxane polydimethylsiloxane (PDMS), polyalkylene oxide, such as polyglycols, polyethylene oxide or polypropylene oxide, polyimide, polycarbonate, polyacetylene, polymethacrylate, polyacrylate, polyelectrolyte, poly(ionic liquids), polyvinyl alcohol and polyether.

The second polymeric material is a different material to the host polymeric material. The second polymeric material is preferably a non-aromatic ring-containing polymeric material (although it is noted that one or more an aromatic rings may be added to the second polymeric material by way of functionalisation to introduce reactive end-groups, as described in further detail below). The second polymeric material typically has a different morphology to the host polymer, and tends to aggregate in the host polymer.

In the case of polydisubstituted siloxanes, examples of the substituents on the silicon atoms in the siloxane structure are hydroxy, alkyl, aryl, alkoxy and aryloxy.

One example of a polymeric material for forming the domains is polydialkyl siloxane. Polydimethyl siloxane is one specific polydialkyl siloxane used below to describe the techniques for forming the polymeric composition comprising the host polymer and domains of the second polymer. Although this polymer is described, it should be understood that other polydialkyl siloxanes, and other classes of second polymeric materials, may equally be used in place of the polydimethyl siloxane.

### Preparation of the Polymeric Composition of the as Separation Membrane

As described previously, the second polymeric material can form separate polymeric particles of a particle size of at least 1 nm distributed within the host polymer (as a physical mixture of the two components), or the second polymeric material is in the forms of segments of polymeric material as a chemically bound constituent within the host polymer, the segments aggregating in the composition to form domains. The first type of situation (where the second polymeric material is in the form of particles) can be prepared by one general process as outline below under “approach 1”. There are a number of alternative techniques for producing variations in the location and arrangement of the segments of second polymeric material within the host polymer, as outlined below under approaches 2 to 3.

Another technique for producing the desired membrane is to append a charged or polar group to a domain forming polymer. This polymer is then added to a solution of the host polymer in a suitable solvent. The addition of the charged or polar groups should facilitate the formation of micelles which should give a structure conceptually similar to that formed via approach 1.

Any membrane fabricated through this result may be further modified by heating to cause annealing and densification of the membrane. This should lead to a decrease in the permeabilities but compensated for by an increase in the selectivities. The effect of heating on a membrane can be found in J. Poly. Sci B: Poly. Phys., 46 (2008) 1879-1890.

### Approach 1

In general terms, approach 1 involves preparing a solution comprising:
a host polymer which is permeable to a target gas species, and has selectivity for the target gas species over a second gas species,
polymeric particles of a second polymeric material having a particle size of at least 0.5 nm and preferably at least 1 nm, wherein the second polymeric material has a higher permeability for the target gas compared to the host polymer, and
a solvent;
   and removing the solvent to produce the polymeric composition comprising a host polymer with the polymeric particles distributed therein.

The polymeric particles may be core-crosslinked star-polymers—that is, polymers having a cross-linked central core, and radiating polymer arms. Such core cross-linked star-polymers can be made by the techniques known in the art. References for the preparation of such polymers are as follows:

1) WO 2007/051252 entitled “Porous polymeric materials and polymer particles for preparation thereof” naming inventors Qiao, Greg Guanghua; Connal, Luke Andrew; Wiltshire, James Thomas
2) WO 99/58588 entitled “Process for microgel preparation” naming inventors Solomon, David Henry; Qiao, Greg Guanghua; Abrol, Simmi.
3) WO 98/31739 entitled “A process for preparing polymeric microgels” naming inventors Solomon, David Henry; Abrol, Simmi; Kambouris, Peter Agapitos; Looney, Mark Graham

This is also described in further detail with reference to the following example. In this example, the polymeric particles are provided by core crosslinked star-polymers (CCSP) comprising cross-linked PDMS containing arms of PDMS. These CCSP particles of PDMS are added to a solution of a host polymer material, otherwise referred to as a “membrane casting solution”. The polymeric composition (the membrane) is then cast in the manner known in the art to yield the desired membrane containing the host polymer with polymeric particles of CCSP PDMS. The resultant polymeric composition has the structure illustrated in FIG. 1. In FIG. 1, the wavy upper and lower lines represent the host polymer, the black circle represents the cross-linked core of the star PDMS polymer and the radiating lines from the black circle represent the PDMS arms.

An example of a host polymer for use in this technique is the polyimide 6FDA-durene. The polymer composition comprising the polyimide 6FDA-durene as the host polymer and particles of PDMS gives a significant increase in the CO₂ permeability and a small decrease in the CO₂/N₂ permeability compared to 6FDA-durene itself. When the technique is applied to the polyimide sold by Huntsman Advanced Materials under the trade name Matrimid® 5218 as the host polymer, an increase in the CO₂ permeability is observed. The nitrogen permeability is below the limits of detection.

Preferably, where the domains are formed by particles of the second polymeric material, the concentration of particles in the polymeric composition is less than is about 50% w/v, preferably between 1 and 10% w/v, and more preferably under 1% w/v. This ensures that the polymeric composition (the gas separation membrane) is sufficiently structurally sound.

Preferably the molecular weight of the particles of second polymeric material have a number average molecular weight of between 50,000 and 10,000,000, more preferably between 70,000 and 1,000,000, most preferably between 100,000 and 200,000.

Preferably the average particle size (diameter) of the polymeric particles is at least 0.5 nm, more preferably at least 1 nm, even more preferably at least 5 nm, and most preferably at least 10 nm. Preferably the average particle size is less than 1000 nm and more preferably less than 80 nm. The ideal particle size is in the range of 15-50 nm.

### Approaches 2-3

Approaches 2 and 3 each involve the formation of the domains of the second polymeric material as aggregations of segments of the second polymeric material within the host polymer. Differences between the approaches relate to the way in which these segments are introduced, the relative amounts of host and second polymeric materials used, and the number of reactive end-groups. These factors impact on the ultimate structure of the polymeric composition obtained which is then used to form the gas separation membrane.

In each case, blocks of host polymeric material (or precursor) are prepared with at least one reactive end group. Reactive end groups are functional groups that are capable of reacting to form a covalent chemical bonds to another segment. Examples of reactive end groups are amines, carboxylic acids or esters, hydroxyl groups, and so forth. The reactive end groups of the first type, which terminate the host polymeric material blocks, need to be reactive to the second type of reactive end groups on the domain-forming polymeric segments. Therefore the first type and second type of reactive end groups are different to one another.

### Approach 2

Under approach 2, the host polymeric material precursor being reacted has one or two reactive end groups, and the domain-forming polymeric material segments being reacted have two reactive end groups, and the method involves reacting at least a 2:1 ratio of the host polymeric material to domain-forming polymeric material to produce a polymeric composition comprising a combination unreacted host polymeric material and 3-block units of reacted polymer comprising a segment of domain-forming material between two segments of host polymeric material. Usually at least a 3:1, and more preferably about a 4:1 excess of host polymeric material to domain-forming polymeric material is used.

The second technique produces block copolymers which incorporate both the host polymer (such as the polyimide) and the domain-forming polymer (such as PDMS). Depending on the relative amounts of host polymeric material and domain-forming polymeric segments reacted, there will be produced block copolymers containing alternating segments of the host and domain-forming polymers—and when a 2:1 ratio or greater is used, a significant portion of the block copolymers formed will contain blocks of host:domain:host. There may also be some unreacted host polymer (especially when greater than a 2:1 ratio of host to domain-forming polymer segments are reacted), and there may be small amounts of 5-block (host:domain:host:domain:host) copolymers formed.

In the example of PDMS and polyimide, the bis hydroxyl or carbinol terminated PDMS of a suitable molecular weight (which corresponds to the preferred molecular weights set out under Approach 1) is first reacted with a reactive end-group introducing compound to introduce reactive end groups. An example of a suitable reactive end-group introducing compound is 4-nitrophenylchloroformate (NPC). This reactive end-group introducing compound contains a haloformate end, for reacting with the hydroxyl functional groups at each end of the PDMS segment. This end-group introducing compound introduces a carboxylic acid ester at each end of each segment of PDMS, which is reactive with the amine. The aromatic ring also added in this functionalisation reaction is lost when the carboxylic acid ester-terminated PDMS segments are reacted with the amine.

The reactive-end group terminated second polymeric material segments (PDMS with reactive end-groups) are then reacted with an excess of amine-terminated polyimides to obtain a mixture of linear polyimide and tri-block copolymers (polyimide-PDMS-polyimide). Upon solvent casting to form a membrane, the poor interaction between PDMS and polyimide forces the PDMS to adopt a complex morphology in which the PDMS segments tend to aggregate. It is expected that structures including micelles (illustrated in FIG. 5), cylinders and channels are all possible, the exact morphology being dependent on the lengths of the various blocks and the interaction between the different blocks.

Preferably the molecular weight of the block co-polymers of host-domain-host is greater than 68,000 gmol⁻¹, especially for the combination of PDMS and the polyimide 6-FDA-durene. This assists to provide a structurally sound membrane. The most successful amine-terminated polyimide prepared have been larger than this lower limit.

The technique of approach 2 has a number of advantages over that of approach 1. The synthetic steps are more robust and will be more straight-forward to scale up. The work up under approach 2 eliminates the need for time consuming purification steps. Another advantage is that the PDMS is forced to be dispersed throughout the polymeric composition, as it is located in segments of a block-copolymer with the host polymer. Further, the larger molecular weights are anticipated to lead to greater structural stability.

The membranes constructed with this approach can be further modified by addition of a linear polymer with the same composition as the domain material. This may be confined to the domain region causing a change in the size and morphologies of the domains.

The carbon dioxide permeability for the polymeric composition produced under approach 2 was determined at multiple carbon dioxide pressures in order to gauge the extent of plasticization. These results are shown in FIG. 6.

The carbon dioxide permeability and carbon dioxide/nitrogen selectivity of the membranes formed from approaches 1 and 2 relative to other literature polymers (data was taken from the Review) are shown in FIG. 8.

### Approach 3

Approach 3 involves the reaction between second polymeric material segments, which are produced in a certain way, and host polymeric material precursors.

The “second” polymeric material segments, typically cross-linked polymeric material segments, are functionalized to introduce multiple (two or more) reactive end-groups. It is further desired for the multiple reactive end-groups introduced into the second polymeric material segments to have properties that will cause the second polymeric material segments to aggregate or form micelles (i.e. domains). Suitable properties of the multiple reactive end-groups that will tend to cause the second polymeric material segments to aggregate (in suitable solvents) are hydrophobic properties. The reactive end-groups of the “second” polymeric material segments need are chosen to be reactive with the corresponding reactive end-groups on the host polymeric material precursor.

The reactive end groups on the host polymeric material precursor may be provided by the addition of new functional groups, or otherwise, the host polymeric material precursor may already contain functional groups that can react with the reactive end-groups on the second polymeric material segments. As one example, polyimide host polymeric material contains imide rings which are reactive with primary amines to form a covalent bond or cross-link. Accordingly, where the second polymeric material segments comprise amine reactive end-groups, these react with the imide of the polyimide to form the target polymer composition.

The polymers produced by this technique will have two notable advantages. Firstly, small volumes or segments of the second polymer (which is target gas-phillic) will be introduced to the host polymer membrane and secondly the gas separation membrane will be cross-linked, which should reduce the membranes propensity to plasticize.

This approach has been applied to amine terminated polyethylene glycol polymers as the “second” polymeric material with amine reactive end-groups, and with 6FDA-durene as the host polymer containing imide rings which react with the amine.

### Further Preparation Details

In the case where the second polymeric material is covalently bound to the host polymer, in the manner of a block-copolymer (under approaches 2 and 3), the second polymeric material may constitute from as little as 0.1% by weight of the polymeric composition, and up to 50% by weight of the polymeric composition, preferably between 0.5% and 10%. This is achieved by selection of the molecular weight of the host polymeric material sections used in forming the block-copolymer, the molecular weight of the segments of second polymeric material (which form the domains), and the relative amounts of each used.

The molecular weight of the host polymer segments is suitably between 10,000 g/mol and 500,000 g/mol, preferably between about 30,000 g/mol and 100,000 g/mol.

Depending on the relative amounts of host polymer and second polymer in the block-copolymer compositions (produced in accordance with approach 2), different ordered microstructures may be obtained. The microstructures obtained for diblock (2-block) compolymers have been well studied, and range from spheres of the second polymer in the host polymer, to disordered mixtures, cylinders, bicontinuous structure, perforated layers and lamellae. Similarly, for triblock copolymers, the morphologies may range from disordered mixtures, spheres, cylinders, bicontinuous structures, perforated layers and lamellar structures.

In other techniques known in the art for improving the combination of permeability and selectivity of a gas separation membrane towards a target gas, nano-sized cavities may be introduced into the membrane, which are of a size to assist solubilisation and permeation of a target gas through the membrane as host polymer. Such techniques may be used in combination with the techniques described above, in which domains of higher-permeability (to the target gas) polymers are introduced into the host polymer, such that the host polymer may also contain such cavities.

According to one technique suitable for creating cavities in polyimides of an appropriate dimension (and with a narrow cavity size distribution), the polyimide membranes (in the case of the present invention, the membrane comprising the polyimide host polymer and the domains) are subjected to thermal rearrangement at a temperature between about 350° C. to 450° C. Under these treatment conditions, the chain structure of the polyimide polymer component is altered in a way that impacts on the chain packing. The resultant material is thermally stable and the structural rearrangements occurring do not progress so far as to cause partial burning (or carbonization) of the underlying polymer structure. Such excessive thermal treatment to cause carbonization adversely impacts on the physical properties (robustness) of the membrane.

The thermal treatment suitably involves increasing the temperature applied to the film up to the target temperature at a suitable rate (such as between about 5 and 10° C. per minute), and holding the film at the target temperature for a period of time (about one hour), followed by a slow cooling to room temperature.

These types of polymers may be used as a host polymer system in combination with the present invention. By incorporating both materials suitable for thermal treatments or nanoparticles such as zeolites, nanoporous carbon, silica and the like, it may be possible to produce a membrane with improved performances.

### Gas Separation Membrane

The gas separation membrane may be constructed into any suitable configuration. These configurations include flat dense membranes, asymmetric hollow fibres, asymmetric flat sheets and composite flat sheet and spiral wound membranes.

The gas separation membrane preferably has a selectivity of at least 4, and a permeability to the target gas of at least 5 barrer.

The gas separation membrane preferably has a selective layer thickness of between 0.05 and 100 micrometres

### EXAMPLES

### General Synthesis of 6FDA-Durene

This host polymer is synthesized by reacting amine terminated 6FDA-durene with reaction 6FDA with a slight excess of 1,4-diaminodurene:

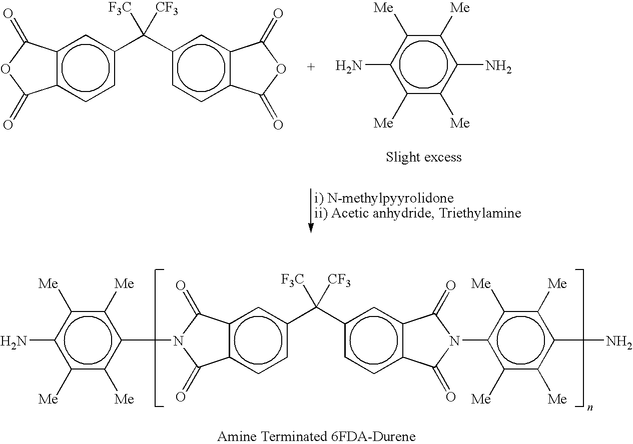

### Example 1

### Synthesis of 6FDA-Durene Membranes Incorporating PDMS Core Crosslinked Star-Polymers

A 10 mL solution of 6FDA-Durene (250 mg) and PDMS star polymer (1.3 mg) in dichloromethane was made up. The solution was pored into a level casting ring (diameter 65 mm) and loosely covered. The casting ring was left overnight to allow the dichloromethane to evaporate. Distilled water was added to allow the membrane to be separated from the glass. The membranes were allowed to air dry overnight and then kept for 4 days at 100° C. to ensure complete remove of all solvents. Membranes were stored in a desiccator prior to usage.

### Example 2

### Single Gas Testing of 6FDA-Durene Membranes Incorporating PDMS Core Crosslinked Star-Polymers

The membrane from specific example 1 was tested on a constant volume variable pressure single gas rig at 35° C. The gases tested in the order of nitrogen (10 atmospheres upstream pressure), oxygen (10 atmospheres upstream pressure), carbon dioxide (10 atmospheres upstream pressure). The calibrated volume occupied 2173.97 cm³ and was kept at a constant temperature (301.5 K).

### Example 3

### Synthesis of 6FDA-Durene Membranes Incorporating PDMS Core Crosslinked Star-Polymers

A 10 mL solution of 6FDA-Durene (250 mg) and PDMS star polymer (1.9 mg) in dichloromethane was made up. The solution was pored into a level casting ring (diameter 65 mm) and loosely covered. The casting ring was left overnight to allow the dichloromethane to evaporate. Distilled water was added to allow the membrane to be separated from the glass. The membranes were allowed to air dry overnight and then kept for 4 days at 100° C. to ensure complete remove of all solvents. Membranes were stored in a desiccator prior to usage.

### Example 4

### Single Gas Testing of 6FDA-Durene Membranes Incorporating PDMS Core Crosslinked Star-Polymers

The membrane from example 3 was tested on a constant volume variable pressure single gas rig at 35° C. The gases tested in the order of nitrogen (10 atmospheres upstream pressure), methane (10 atmospheres upstream pressure), carbon dioxide (10 atmospheres upstream pressure). The calibrated volume occupied 2173.97 cm³ and was kept at a constant temperature (301.5 K).

### Example 5

### Synthesis of Matrimid 5218 Membranes Incorporating PDMS Core Crosslinked Star-Polymers

A 10 mL solution of Matrimid 5218 (250 mg) and PDMS star polymer (1.3 mg) in dichloromethane was made up. The solution was pored into a level casting ring (diameter 65 mm) and loosely covered. The casting ring was left overnight to allow the dichloromethane to evaporate. Distilled water was added to allow the membrane to be separated from the glass. The membranes were allowed to air dry overnight and then kept for 4 days at 100° C. to ensure complete remove of all solvents. Membranes were stored in a desiccator prior to usage.

### Testing of Example 5

The membrane from specific example 4 was tested on a constant volume variable pressure single gas rig at 35° C. The gases tested in the order of nitrogen (10 atmospheres upstream pressure), oxygen (10 atmospheres upstream pressure), carbon dioxide (10 atmospheres upstream pressure). The calibrated volume occupied 2173.97 cm³ and was kept at a constant temperature (301.5 K).

### Example 6

### Synthesis of NPC Functionalized PDMS

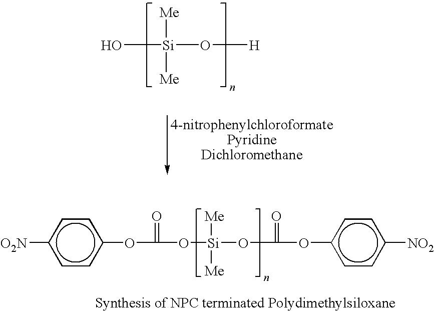

Hydroxyl terminated polydimethylsiloxane MW=980 (7.02 mL) was dissolved in dichloromethane (17 mL). To this solution 4-nitrophenylchloroformate (0.800 g) and pyridine (0.53 mL) were added. The solution was stirred for 24 hours. The solution was filtered and then the solvent was removed under reduced pressure. The polymer was then extracted into petroleum spirits. The petroleum spirits were removed under reduced pressure yielding a viscous liquid. Petroleum spirits when then used again to extract the polymer. The solution was filtered and the solvent removed under reduced pressure yielding a colourless liquid.

### Example 7

### Synthesis of Low Molecular Weight Amine Functionalized 6FDA-Durene

A solution of 6FDA (3.000 g) and 1,4-diaminodurene (1.110 g) in anhydrous N-methylpyrrolidone (20 mL) was stirred for 24 hours under argon. Acetic anhydride (1.7 mL) and triethylamine (0.7 mL) were added and the solution was stirred for another 24 hours. The solution was slowly added to rapidly stirring methanol (200 mL) and the precipitated polymer was collected by filtration. The polymer was dissolved in dichloromethane (35 mL) and slowly added to rapidly stirring methanol (200 mL). The solids were recollected by filtration, yielding a white solid (3.683 g).

### Example 8

### Synthesis of Triblock 6FDA-Durene/PDMS (1:1 Ratio) Polymer

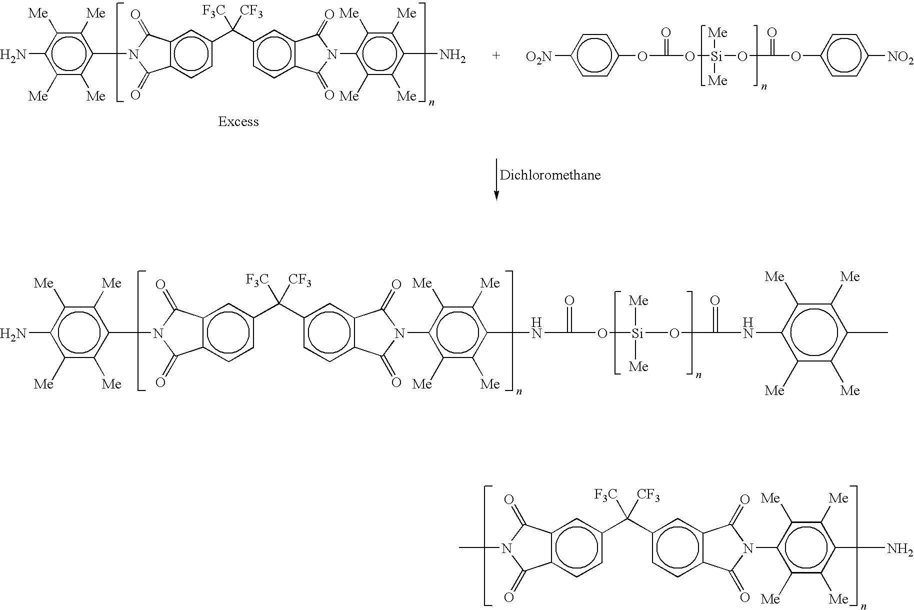

A solution of the NPC functionalized PDMS from specific example 6 (0.0231 g) and amine functionalized 6FDA-durene from specific example 7 (1.000 g) in dicholoromethane (20 mL) for 24 hours. The solution was slowly added to methanol (100 mL) and the solids were collected by filtration. The solids were washed with methanol and hexane.

### Example 9

### Synthesis of Triblock 6FDA-Durene/PDMS (1:1 Ratio) Membranes

A 10 mL solution of the polymer synthesized in specific example 8 (250 mg) in dichloromethane was made up. The solution was pored into a level casting ring (diameter 65 mm) and loosely covered. The casting ring was left overnight to allow the dichloromethane to evaporate. Distilled water was added to allow the membrane to be separated from the glass. The membranes were allowed to air dry overnight and then kept for 4 days at 100° C. to ensure complete remove of all solvents. Membranes were stored in a desiccator prior to usage.

### Example 10

### Single Gas Testing of Triblock 6FDA-Durene/PDMS (1:1 Ratio) Membranes

The membrane from specific example 9 was tested on a constant volume variable pressure single gas rig at 35° C. The gases tested in the order of nitrogen (10 atmospheres upstream pressure), methane (10 atmospheres upstream pressure), carbon dioxide (2, 5, 10, 15 and 20 atmospheres upstream pressure). The calibrated volume occupied 2173.97 cm³ and was kept at a constant temperature (301.5 K).

### Example 11

### Synthesis of Triblock 6FDA-Durene/PDMS (1:2 Ratio) Polymer

A solution of the NPC functionalized PDMS from specific example 6 (0.0103 g) and amine functionalized 6FDA-durene from specific example 7 (0.894 g) in dicholoromethane (20 mL) for 24 hours. The solution was slowly added to methanol (100 mL) and the solids were collected by filtration. The solids were washed with methanol and hexane.

### Example 12

### Synthesis of Triblock 6FDA-Durene/PDMS (1:2 Ratio) Membranes

A 10 mL solution of the polymer synthesized in specific example 11 (250 mg) in dichloromethane was made up. The solution was pored into a level casting ring (diameter 65 mm) and loosely covered. The casting ring was left overnight to allow the dichloromethane to evaporate. Distilled water was added to allow the membrane to be separated from the glass. The membranes were allowed to air dry overnight and then kept for 4 days at 100° C. to ensure complete remove of all solvents. Membranes were stored in a desiccator prior to usage.

### Example 13

### Single Gas Testing of Triblock 6FDA-Durene/PDMS (1:2 Ratio) Membranes

The membrane from specific example 12 was tested on a constant volume variable pressure single gas rig at 35° C. The gases tested in the order of nitrogen (10 atmospheres upstream pressure), methane (10 atmospheres upstream pressure), carbon dioxide (2, 5, 10, 15 and 20 atmospheres upstream pressure). The calibrated volume occupied 2173.97 cm³ and was kept at a constant temperature (301.5 K).

### Example 14

### Synthesis of Triblock 6FDA-Durene/PDMS (1:4 Ratio) Polymer

A solution of the NPC functionalized PDMS from specific example 6 (0.0101 g) and amine functionalized 6FDA-durene from specific example 7 (1.944 g) in dicholoromethane (20 mL) for 24 hours. The solution was slowly added to methanol (100 mL) and the solids were collected by filtration. The solids were washed with methanol and hexane.

### Example 15

### Synthesis of Triblock 6FDA-Durene/PDMS (1:4 Ratio) Membranes

A 10 mL solution of the polymer synthesized in specific example 14 (250 mg) in dichloromethane was made up. The solution was pored into a level casting ring (diameter 65 mm) and loosely covered. The casting ring was left overnight to allow the dichloromethane to evaporate. Distilled water was added to allow the membrane to be separated from the glass. The membranes were allowed to air dry overnight and then kept for 4 days at 100° C. to ensure complete remove of all solvents. Membranes were stored in a desiccator prior to usage.

### Example 16

### Synthesis of 6FDA-Durene Membranes Incorporating PDMS Core Crosslinked Star-Polymers

A 10 mL solution of 6FDA-Durene (250 mg) and PDMS star polymer (2.5 mg) in dichloromethane was made up. The solution was pored into a level casting ring (diameter 65 mm) and loosely covered. The casting ring was left overnight to allow the dichloromethane to evaporate. Distilled water was added to allow the membrane to be separated from the glass. The membranes were allowed to air dry overnight and then kept for 4 days at 100° C. to ensure complete remove of all solvents. The membranes formed were less ideal because of cracking.

### Example 17

### Synthesis of 6FDA-Durene Membranes Incorporating PDMS Core Crosslinked Star-Polymers

A 10 mL solution of 6FDA-Durene (250 mg) and PDMS star polymer (3.3 mg) in dichloromethane was made up. The solution was pored into a level casting ring (diameter 65 mm) and loosely covered. The casting ring was left overnight to allow the dichloromethane to evaporate. Distilled water was added to allow the membrane to be separated from the glass. The membranes were allowed to air dry overnight and then kept for 4 days at 100° C. to ensure complete remove of all solvents. The membranes formed were less ideal because of cracking.

### Example 18

### Synthesis of Extended Molecular Weight Amine Terminated 6FDA-Durene Polymer

A solution of 6FDA (3.000 g) and 1,4-diaminodurene (1.109 g) in anhydrous N-methylpyrrolidone (20 mL) was stirred for 24 hours under argon. Another portion of 1,4-diaminodurene (0.110 g) was added and the solution was stirred for another 24 hours. Acetic anhydride (1.7 mL) and triethylamine (0.7 mL) were added and the solution was stirred for another 24 hours. The solution was slowly added to rapidly stirring methanol (200 mL) and the precipitated polymer was collected by filtration. The polymer was dissolved in dichloromethane (35 mL) and slowly added to rapidly stirring methanol (200 mL). The solids were recollected by filtration.

### Example 19

### Synthesis of NPC Terminated Polydimethylsiloxane

Carbianol Terminated Polydimethylsiloxane MW=1000-1250 (0.98 g) was dissolved in dichloromethane (15 mL). To this solution 4-nitrophenylchloroformate (0.702 g) was added. The solution was stirred for six hours. Pyridine (5 mL) was added and the solution was stirred for a further 24 hours. The solution was filtered and then the volume was removed under reduced pressure to approximately 5 mL. The solution was slowly poured into petroleum spirits (30 mL). The solution was filtered and the solvent removed under reduced pressure yielding a viscous liquid. Petroleum spirits when then used again to extract the polymer. The solution was filtered and the solvent removed under reduced pressure yielding a viscous colourless liquid.

### Example 20

### Synthesis of Triblock 6FDA-Durene/PDMS (1:1 Ratio) Polymer

A solution of the NPC functionalized PDMS from specific example 17 (3.6 mg) and amine functionalized 6FDA-durene from specific example 16 (0.300 g) in dicholoromethane (20 mL) for 24 hours. The solution was slowly added to hexane (20 mL) and the solids were collected by filtration. The solids were washed with methanol and hexane. The white product was dried in a vacuum oven at 100° C. for seventeen hours.

### Example 21

### Synthesis of Triblock 6FDA-Durene/PDMS (1:1 Ratio) Membranes

A 10 mL solution of the polymer synthesized in specific example 18 (250 mg) in dichloromethane was made up. The solution was pored into a level casting ring (diameter 65 mm) and loosely covered. The casting ring was left overnight to allow the dichloromethane to evaporate. Distilled water was added to allow the membrane to be separated from the glass. The membranes were allowed to air dry overnight and then kept for 4 days at 100° C. to ensure complete remove of all solvents. Membranes were stored in a desiccator prior to usage.

### Example 22

### Single Gas Testing of Triblock 6FDA-Durene/PDMS (1:1 Ratio) Membranes

The membrane from specific example 19 was tested on a constant volume variable pressure single gas rig at 35° C. The gases tested in the order of nitrogen (10 atmospheres upstream pressure), methane (10 atmospheres upstream pressure), carbon dioxide (10 atmospheres upstream pressure). The calibrated volume occupied 2173.97 cm³ and was kept at a constant temperature (301.5 K).

### Example 23

### Synthesis of Triblock 6FDA-Durene/PDMS (1:2 Ratio) Polymer

A solution of the NPC functionalized PDMS from specific example 17 (1.8 mg) and amine functionalized 6FDA-durene from specific example 16 (0.300 g) in dicholoromethane (20 mL) for 24 hours. The solution was slowly added to hexane (20 mL) and the solids were collected by filtration. The solids were washed with methanol and hexane. The white product was dried in a vacuum oven at 100° C. for seventeen hours.

### Example 24

### Synthesis of Triblock 6FDA-Durene/PDMS (1:2 Ratio) Membranes

A 10 mL solution of the polymer synthesized in specific example 21 (250 mg) in dichloromethane was made up. The solution was pored into a level casting ring (diameter 65 mm) and loosely covered. The casting ring was left overnight to allow the dichloromethane to evaporate. Distilled water was added to allow the membrane to be separated from the glass. The membranes were allowed to air dry overnight and then kept for 4 days at 100° C. to ensure complete remove of all solvents. Membranes were stored in a desiccator prior to usage.

### Example 25

### Single Gas Testing of Triblock 6FDA-Durene/PDMS (1:2 Ratio) Membranes

The membrane from specific example 22 was tested on a constant volume variable pressure single gas rig at 35° C. The gases tested in the order of nitrogen (10 atmospheres upstream pressure), methane (10 atmospheres upstream pressure), carbon dioxide (10 atmospheres upstream pressure). The calibrated volume occupied 2173.97 cm³ and was kept at a constant temperature (301.5 K).

### Test Results

The polymers prepared as described above were subjected to the permeability testing as outlined in the detailed description above. The permeability test results are set out in Tables 1 and 2.

TABLE 1
Permeabilities and selectivities for membranes having core crosslinked star-
polymers incorporating PDMS arms (35° C. 10 atmosphere upstream pressure)

| | | | | CH₄ | N₂ | CO₂/N₂ | CO₂/CH₄ |
|---|---|---|---|---|---|---|---|
| | Membrane | CO₂ Perm | O₂ Perm | Perm | Perm | selectivity | selectivity |
| Example 3 | 6FDA- | 1886 | — | 76.8 | 92.2 | 20.5 | 24.6 |
| | Durene/0.75% | | | | | | |
| | PDMS CCSP | | | | | | |
| | nanocomposite | | | | | | |
| Example 1 | 6FDA- | 687 | 210 | — | 76.5 | 9.0 | — |
| | Durene/0.5% | | | | | | |
| | PDMS CCSP | | | | | | |
| | nanocomposite | | | | | | |
| Prior art | 6FDA-Durene | 358 | 66.2 | — | 36.0 | 9.9 | — |
| Example 5 | Matrimid 0.5% | 8.4 | <0.5 | — | <0.5 | — | — |
| | CCSP | | | | | | |
| | nanocomposite | | | | | | |
| Prior art | Matrimid | 6.5 | | | 0.25 | 26 | — |
| | (literature) | | | | | | |

TABLE 2
Permeabilities and selectivities for membranes synthesized via
approach 2 (35° C. 10 atmosphere upstream pressure)

| | | | | | CO₂/N₂ | |
|---|---|---|---|---|---|---|
| | | CO₂ | CH₄ | N₂ | selec- | CO₂/CH₄ |
| | Membrane | Perm | Perm | Perm | tivity | selectivity |
| Example 10 | 6FDA-PDMS | 2513 | 109 | 141 | 17.8 | 23.1 |
| | triblock | | | | | |
| | copolymer (1:1 | | | | | |
| | ratio)^{a} | | | | | |
| Example 13 | 6FDA-PDMS | 2575 | 133 | 159 | 16.2 | 19.4 |
| | triblock | | | | | |
| | copolymer (1:2 | | | | | |
| | ratio)^{b} | | | | | |
| Example 22 | 6FDA-PDMS | 1846 | 78 | 107 | 17.3 | 23.7 |
| | triblock | | | | | |
| | copolymer (1:1 | | | | | |
| | ratio)^{c} | | | | | |
| Example 25 | 6FDA-PDMS | 816 | 78.9 | 85 | 9.6 | 10.3 |
| | triblock | | | | | |
| | copolymer (1:2 | | | | | |
| | ratio)^{d} | | | | | |

^{a}Molecular weight 6FDA-Durene blocks = 57,000 gmol⁻¹, molecular weight of PDMS = 980 gmol⁻¹.
^{b}Molecular weight 6FDA-Durene blocks = 57,000 gmol⁻¹, molecular weight of PDMS = 980 gmol⁻¹
^{c}Molecular weight 6FDA-Durene blocks = 120,000 gmol⁻¹, molecular weight of PDMS = 1000-1250 gmol⁻¹
^{d}Molecular weight 6FDA-Durene blocks = 120,000 gmol⁻¹, molecular weight of PDMS = 1000-1250 gmol⁻¹

FIG. 9 compares the carbon dioxide permeability with the carbon dioxide/methane selectivity for the membranes synthesised in examples 3, 10 and 13 against a range of literature polymers. Robeson's upper bound is shown with a broken line. All of the examples listed here show a combination of high permeabilities and selectivities which places them significantly above the upper bound.

It will be understood to persons skilled in the art of the invention that many modifications may be made without departing from the spirit and scope of the invention.

In the claims which follow and in the preceding description of the invention, except where the context requires otherwise due to express language or necessary implication, the word “comprise” or variations such as “comprise” or “comprising” is used in an inclusive sense, i.e. to specify the presence of the stated features but not to preclude the presence or addition of further features in various embodiments of the invention.

1. A gas separation membrane for separating a target gas species from a second gas species in a gas mixture, the membrane comprising:
a host polymer which is permeable to the target gas species and has selectivity for the target gas species over the second gas species; and
domains of a polymeric material having a higher permeability for the target gas compared to the host polymer.

2. The gas separation membrane of claim 1, wherein the domains of polymeric material are at least 0.5 nm and preferably at least 1 nm in diameter.

3. The gas separation membrane of claim 1, wherein the gas separation membrane has a combination of permeability and selectivity that is above Robeson's upper bound.

4. The gas separation membrane of claim 1, wherein the target gas species is selected from the group consisting of CO₂, He, O₂ and N₂

5. The gas separation membrane of claim 1, wherein the target gas species is CO₂, and the second gas species is selected from the group consisting of N₂, H₂, CH₄, O₂, H₂O, H₂S, SOₓ and NOₓ.

6. The gas separation membrane of claim 1, wherein the permeability of the host polymer to the target gas is at least 5 barrer.

7. The gas separation membrane of claim 1, wherein the selectivity of the host membrane for the target gas species over the second gas species is at least 4.

8. The gas separation membrane of claim 1, wherein the selectivity of the gas separation membrane for the target gas species over the second gas species is at least 4.

9. The gas separation membrane of claim 1, wherein the host polymer is an aromatic ring-containing polymer.

10. The gas separation membrane of claim 1, wherein the host polymer is selected from the group consisting of: polyamides and polyimides; polyacetylenes; polyanilines; polysulfones; poly(styrenes); polycarbonates; cellulosic polymers; polycarbonates; polyethers; polyetherimides; polyetherketones; poly(arylkene ethers); poly(arylene oxides); poly(esteramide-diisocyanate); polyurethanes; polyesters; poly(phenylene oxide)s; poly(pyrrolone)s; polysulfides; poly(ethylene); polymers of intrinsic microporosity, polyvinyl compounds and copolymers thereof.

11. The gas separation membrane of claim 1, wherein the host polymer is a polyimide.

12. The gas separation membrane of claim 11, wherein the polyimide is derived from the reaction of a diamine with a dicarboxylic acid or dianhydride selected from the group consisting of: 4,4′-(hexafluoroisopropylidene)-diphthalic anhydride (6FDA), 3,3′,4,4′-bisphenyltetracarboxylic dianhydride (BPDA), 4,4′-oxydiphthalic anhydride (OPDA), 3,3′4,4′-benzophenonetetracarboxylic acid dianhydride (BTDA), 1,2,3,5-benzenetetracarboxylic anhydride (PMDA) and 1,4,5,8-naphthalenic tetracarboxylic dianhydride (NTDA).

13. The gas separation membrane of claim 11, wherein the polyimide is derived from the reaction of a dicarboxylic acid or a dianhydride with diamine selected from the group consisting of: 2,2′-bis(3-amino-4-hydroxylphenyl)hexafluoropropane (bisAPAF), 4-(4-aminophenoxy)benzenamine (4,4′-ODA), 3-(4-aminophenoxy)benzenamine (3,4′-ODA), 3-(3-aminophenoxy)benzenamine (3,3′-ODA), 1,4-diaminodurene, 2,5-diamino-1,4-benzenedithiol (DABT), 5-amino-1-(4′-aminophenyl)-1,3,3-trimethylindane, 6-amino-1-(4′-aminophenyl)-1,3,3-trimethylindane and 3,3′-diaminobenzidine (DAB).

14. The gas separation membrane of claim 1, wherein the permeability of the second polymeric material is at least 50% more permeable to the target gas compared to the host polymer.

15. The gas separation membrane of claim 1, wherein the second polymeric material is selected from the group consisting of polydisubstitutedsiloxane, polyalkylene oxide, polyimide, polycarbonate, polyacetylene, polymethacrylate, polyacrylate, polyelectrolyte, poly(ionic liquids), polyvinyl alcohol and polyether, or a combination thereof.

16. The gas separation membrane of claim 1, wherein the second polymeric material is a non-aromatic ring-containing polymeric material.

17. The gas separation membrane of claim 1, wherein the second polymeric material contain either a charged end group, or an polar end group such as carbonyl, hydroxyl, amine, ether, or siloxane.

18. The gas separation membrane of claim 1, wherein the domains are formed by particles of the second polymeric material.

19. The gas separation membrane of claim 18, wherein the concentration of particles of second polymeric material in the polymeric composition is less than about 50% w/v, preferably between 1 and 10% w/v, more preferably under 1% w/v.

20. The gas separation membrane of claim 18, wherein the molecular weight of the particles of second polymeric material have a number average molecular weight of between 50,000 and 10,000,000.

21. The gas separation membrane of claim 1, wherein the average particle size of the polymeric particles is at least 5 nm and less than 80 nm.

22. The gas separation membrane of claim 1, wherein particles of second polymeric material are core-crosslinked star-polymers.

23. The gas separation membrane of claim 1, wherein the domains of the second polymeric material comprise segments of the second polymeric material covalently bound to segments of the host polymer.

24. The gas separation membrane of claim 23, wherein the second polymeric material constitutes between 0.1% by weight of the polymeric composition and up to 50% by weight of the polymeric composition.

25. The gas separation membrane of claim 23, wherein the molecular weight of the host polymer segments is between 10,000 g/mol and 500,000 g/mol.

26. The gas separation membrane of claim 1, comprising a selective layer thickness of between 0.1 and 100 micrometres.

27. A polymer composition for forming a gas separation membrane, the polymer composition comprising:
a host polymer which is permeable to the target gas species and has selectivity for the target gas species over the second gas species; and
domains of a polymeric material having a higher permeability for the target gas compared to the host polymer.

28. A method for producing a gas separation membrane polymeric composition comprising combining a host polymer which is permeable to a target gas species, and has selectivity for the target gas species over a second gas species, and polymeric particles of a second polymeric material having a particle size of at least 0.5 nm and preferably at least 1 nm, wherein the second polymeric material has a higher permeability for the target gas compared to the host polymer.

29. The method of claim 28, wherein the method comprises combining the host polymer with particles of second polymeric material with a number average molecular weight of between 50,000 and 10,000,000.

30. The method of claim 28, wherein the method comprises combining the host polymer with particles of second polymeric material with an average particle size of at least 5 nm and less than 80 nm.

31. The method of claim 28, wherein the method comprises combining the host polymer with particles of second polymeric material which are core-crosslinked star-polymers.

32. The method of claim 28, wherein the host polymer and particles of polymeric composition are combined with a solvent, and the method comprises removing the solvent to produce the polymeric composition comprising a host polymer with the polymeric particles distributed therein.

33. A method for producing a gas separation membrane polymeric composition comprising reacting:
(i) a host polymeric material or precursor having at least one reactive group of a first type, with
(ii) domain-forming polymeric material segments having at least one reactive end group of a second type which is reactive with the reactive group of the first type,
to produce a polymeric composition in which multiple segments of the second polymeric material aggregate to form domains within the host polymer, wherein the host polymer is permeable to a target gas and has selectivity for the target gas over a second gas, and the domain-forming polymeric material has higher permeability to the target gas compared to the host polymer.

34. The method of claim 33, wherein the host polymeric material precursor being reacted has one or two reactive end groups, and the domain-forming polymeric material segments being reacted have two reactive end groups, and the method involves reacting at least a 2:1 mole ratio of the host polymeric material to domain-forming polymeric material to produce a polymeric composition comprising 3-block units of reacted polymer comprising a segment of domain-forming material between two segments of host polymeric material.

35. The method of claim 33, wherein the host polymeric material being reacted comprises multiple reactive groups, and the second polymeric material segments each have multiple reactive end groups, so that the reaction yields a cross-linked polymeric composition comprising the host polymeric material and segments of second polymeric material.

36. Use of a polymeric material as a gas separation membrane, the polymeric material comprising:
a host polymer which is permeable to the target gas species and has selectivity for the target gas species over the second gas species; and
domains of a polymeric material having a higher permeability for the target gas compared to the host polymer.

37. A method for separating a target gas from a second gas in a gas mixture comprising passing the gas mixture through or alongside a gas separation membrane comprising:
a host polymer which is permeable to the target gas species and has selectivity for the target gas species over the second gas species; and
domains of a polymeric material having a higher permeability for the target gas compared to the host polymer.
